(19) United States
(12) Patent Application Publication
(10) Pub. No.: US 2006/0196593 A1
(43) Pub. Date: Sep. 7, 2006

(54) Atmosphere-controlled resin-bonding apparatus, bonding method and resin member bonded thereby

(75) Inventors: Tadahiro Ohmi, Miyagi (JP); Kazumi Tsukamoto, Miyagi (JP); Yasuyuki Shirai, Miyagi (JP)

Correspondence Address: FOLEY AND LARDNER LLP;SUITE 500, 3000 K STREET NW, WASHINGTON, DC, 20007, US

(73) Assignee: Tadahiro OHMI

(21) Appl. No.: 11/223,141

(22) Filed: Sep. 12, 2005

(30) Foreign Application Priority Data
Mar. 26, 2004 (JP) 2004-93240

(51) Int. Cl. B31B 1/60; B32B 37/00; B32B 9/04

(52) U.S. Cl. 156/60; 156/381; 428/411.1

(57) ABSTRACT

By performing thermal fusion bonding in the state where a bonding portion is covered with a bonding portion cover and the concentrations of oxygen and moisture inside the bonding portion cover are set lower than the concentrations of oxygen and moisture in the atmosphere, it is possible to reduce elution from a bonded resin-based pipe.

### BACKGROUND OF THE INVENTION

This invention relates to a bonding apparatus for plastic members or the like in the electronic component manufacturing field requiring highly clean environment and materials in the manufacture. More specifically, this invention relates to a thermal fusion-bonding apparatus and fusion-bonding method for melting and bonding members by applying heat thereto and a resin member fusion-bonded thereby, for use in the execution of pure water or ultrapure water conveyance piping.

In recent years, following the miniaturization, advanced functionality and increased performance of products in the semiconductor and liquid-crystal display manufacturing fields, what are extremely highly purified have been required with respect also to utilities used in the manufacture. For example, the quality of ultrapure water or the like has been required to be extremely highly pure, wherein the total amount of impurities allowed to be present in the water is in the order of ppb (one millionth) to ppt (one trillionth). Particularly, the allowable amount of metal impurities in the water has started to shift from the order of ppt to the order of ppq (one 1000-trillionth). On the other hand, the allowable amount of organic matter (TOC: total organic carbon) in the water is still in the order of ppb and thus the allowable value thereof is higher than the other impurities. In these circumstances, purification of members to be used has been developed as an attempt to reduce the TOC amount in the water. This is well exemplified by clean PVC (clean polyvinyl chloride), fluororesin-based PVDF (polyvinylidene fluoride), or the like used in ultrapure water piping or the like, which is cleaner than general-purpose PVC piping.

In the execution of piping, an adhesive or the like has conventionally been used for bonding. However, since elution of organic matter from the adhesive has arisen as a problem, thermal fusion-bonding apparatuses have often been used. The thermal fusion-bonding apparatus employs a method of heating a bonding portion to near the melting point of bonding members, thereby melting and bonding the members.

In the method of raising the temperature to near the melting point to carry out the fusion bonding at the time of bonding the resin members as described above, the resin forming the piping reacts with oxygen and moisture in the atmosphere so that oxidative degradation, decomposition/dissociation, or the like of the resin material is already generated at the fusion-bonding portion. This bonded portion is one of causes for elution of TOC components into the ultrapure water.

Japanese Unexamined PatentApplication Publication (JP-A) No. H8-285166 (patent document 1) proposes a pipe header which is usable for piping capable of transporting even ultrapure water. This pipe header comprises a main pipe in the form of a thermoplastic resin pipe and branch pipes connected to the main pipe. Each branch pipe is in the form of a short pipe with a curved flange and the curved flange is fusion-bonded along the outer periphery of the thermoplastic resin pipe.

As described above, the thermal fusion-bonding method in the atmosphere-open state cannot avoid the elution of the TOC components into the water due to the degradation of the fusion-bonded portion. Therefore, there has arisen a problem that the TOC amount in the ultrapure water is not easily reduced immediately after the execution of the piping and it is necessary to let the water run for days in order to guarantee the quality of the water and to continue it until the eluted organic matter (TOC components) is exhausted.

On the other hand, as a result of assiduous studies by the inventors of this invention, it has been found out that the degradation of the resin forming the piping, which occurs in the thermal fusion bonding, is caused by oxygen and moisture in the atmosphere.

It has become clear that, for reducing the elution from the fusion-bonded portion and enhancing the bonding strength, it is necessary to carry out the bonding after controlling the oxygen concentration in the bonding environment and sufficiently removing adsorbed moisture on the surface of the bonding portion immediately before the bonding. Further, it has become clear that, for realizing the low oxygen concentration environment and the low moisture concentration environment, it is necessary to cover a fusion-bonding apparatus with a member having low permeability to gas and moisture to thereby isolate it from the external environment and let the gas flow there and, not only to reduce the oxygen and moisture amount contained in the flowing supply gas but also to form the surface inside the apparatus serving as a flow path for the gas to be an inactive surface where the moisture is difficult to be adsorbed.

On the other hand, patent document 1 does not identify any issues raised when bonding the ultrapure water conveyance pipes.

### SUMMARY OF THE INVENTION

It is therefore an object of this invention to provide an atmosphere-controlled thermal fusion-bonding apparatus and fusion-bonding method capable of bonding resin members without changing the quality of a bonded portion, where the resin members are melted and bonded together by the application of heat, free of oxidative degradation or the like and thus while maintaining the original properties possessed by the members.

It is another object of this invention to provide a resin member bonded by the foregoing thermal fusion-bonding apparatus or fusion-bonding method.

A bonding apparatus provided by this invention is a bonding apparatus that applies heat to bonding resin members to thereby melt and bond them and is characterized in that a bonding portion is covered and the oxygen concentration and the moisture concentration of a bonding atmosphere are lower as compared with the oxygen concentration and the moisture concentration of an atmosphere outside the apparatus and in that the oxygen concentration is 1 vol % or less and the moisture concentration is 0.1 vol % or less in the bonding environment at the bonding portion. Preferably, the oxygen concentration is 100 vol ppm or less and the moisture concentration is 100 vol ppm or less in the bonding environment and, more preferably, the oxygen concentration is 1 vol ppm or less and the moisture concentration is 1 vol ppm or less.

A heating method of the bonding apparatus provided by this invention for heating the bonding portion is not limited to particular means, but is preferably one of a heater and a laser.

The bonding apparatus of this invention is characterized in that at least the bonding portion is supplied with a low dew point gas. The bonding apparatus has a supply port for supplying the low dew point gas from the exterior of the apparatus and an exhaust port. It is preferable that the oxygen content of the low dew point gas at the supply port be 100 vol ppm or less and the moisture content thereof be 100 vol ppm or less.

A pipe for supplying the low dew point gas is also not limited to particular means. However, in order to supply the gas with the oxygen content of 100 vol ppm or less and the moisture content of 100 vol ppm or less to the bonding portion, it is preferably at least one of an electrolytically polished stainless surface, an electrochemically polished stainless surface, an electrolytically polished or electrochemically polished surface containing a chromium oxide as a main component, and an electrolytically polished or electrochemically polished surface containing an aluminum oxide as a main component.

In the bonding apparatus of this invention, the low dew point gas is characterized by containing at least one of nitrogen, helium, neon, argon, krypton, xenon, and hydrogen. Although nitrogen, helium, neon, argon, krypton, xenon, hydrogen, or the like is cited as an example of the foregoing gas, these may be mixed for use. In terms of suppressing oxidation of the bonding portion, it is preferable to mix hydrogen at 0.1 vol % or more.

A material, covering the bonding portion, of the bonding apparatus of this invention is not particularly limited as long as the environment can be ensured wherein the oxygen concentration is 1 vol % or less and the moisture concentration is 0.1 vol % or less. It is preferably at least one of an electrolytically polished stainless surface, an electrochemically polished stainless surface, an electrolytically polished or electrochemically polished surface containing a chromium oxide as a main component, and an electrolytically polished or electrochemically polished surface containing an aluminum oxide as a main component.

Further, the bonding apparatus of this invention is characterized by comprising a mechanism for reducing the oxygen concentration to 1 vol % or less and the moisture concentration to 0.1 vol % or less at the bonding portion. As means for reducing the oxygen concentration and the moisture concentration to 1 vol % or less at the bonding portion, there is cited a method of supplying a gas with a low oxygen concentration and a low dew point. Further, by repeating the gas supply and decompression at the bonding portion, it is possible to reduce the oxygen concentration to 1 vol % or less and the moisture concentration to 0.1 vol % or less more quickly, which is thus more preferable. The bonding may be carried out while supplying the gas or in the state where the supply is stopped.

The bonding apparatus of this invention is characterized by comprising meters for measuring the oxygen concentration and the moisture concentration inside the apparatus. As means for measuring the oxygen concentration, it is preferable to use one of an oxygen analyzer and a gas chromatograph. As means for measuring the moisture concentration, it is preferable to use one of a dew point meter, an infrared spectrometer, and an atmospheric pressure ionization mass spectrometer (API-MS).

A resin member bonding method of this invention is a method of applying heat to resin members to thereby melt and bond them. The bonding resin members are not particularly limited, but each may be a hydrocarbon-based member that preferably contains, for example, at least one of resins of vinyl chloride (PVC), cycloolefin polymer (COP), polypropylene (PP), polyethylene (PE), and polyetheretherketone (PEEK). On the other hand, it may be a fluorocarbon-based member that preferably contains, for example, at least one of resins of polyvinylidene fluoride (PVDF), tetrafluoroethylene (PTFE), perfluoroalkoxylvinylether (PFA), tetrafluoroethylene-hexafluoropropylene copolymer (FEP), tetrafluoroethylene-ethylene copolymer (ETFE), and vinyl fluoride (PVF).

It is preferable that the resin members be bonded together by the use of the apparatus provided by this invention wherein the resin is heated and melted after reducing the oxygen concentration to 1 vol % or less and the moisture concentration to 0.1 vol % or less in the bonding environment at the bonding portion, thereby carrying out the bonding.

The bonding apparatus of this invention is capable of controlling the oxygen concentration and the moisture concentration in the atmosphere at the bonding portion to be lower as compared with those in the atmosphere outside the apparatus so that it is possible to implement thermal fusion bonding without degradation of the bonding resin members. Consequently, it becomes possible to reduce the elution from a bonded resin member and, further, by using the resin member obtained by the present apparatus or method in the execution of ultrapure water supply piping, it is possible to achieve the TOC water quality of ultrapure water in a significantly shorter time than conventional.

### BRIEF DESCRIPTION OF THE DRAWINGS

FIG. 1 is a schematic diagram showing a bonding apparatus and an evaluation apparatus for evaluating bonding implemented by the bonding apparatus;

FIG. 2 is a graph showing the results of evaluating bonding by the use of the evaluation apparatus shown in FIG. 1 and, herein, showing a change in COP thermal decomposition temperature according to a change in oxygen concentration in a bonding portion cover;

FIG. 3 is a graph showing the results of evaluating bonding by the use of the evaluation apparatus shown in FIG. 1 and, herein, showing a change in COP thermal decomposition temperature according to a change in moisture concentration in the bonding portion cover;

FIG. 4 is a schematic diagram showing a bonding apparatus and an evaluation apparatus for measuring an elution amount in a pipe thermally fusion-bonded by the bonding apparatus; and

FIG. 5 is a diagram showing an elution amount evaluation state for evaluating the elution amount of the fusion-bonded clean PVC pipe.

### DESCRIPTION OF THE PREFERRED EMBODIMENT

Hereinbelow, examples of this invention will be described. As a matter of course, this invention is not to be limited to the following examples.

The analysis conditions in the following examples and comparative examples are as follows.

(Analysis Condition 1)

Fourier Transform Infrared Spectroscopic Analysis (hereinafter abbreviated as “FT-IR analysis”)

Apparatus: FTS-50A manufactured by Bio-Rad Laboratories, Inc.

(Analysis Condition 2)

Atmospheric Pressure Ionization Mass Spectrometry (hereinafter abbreviated as “API-MS analysis”)

Apparatus: UG-400 manufactured by Renesas Technology Corp.

(Analysis Condition 3)

Total Organic Carbon Analysis (hereinafter abbreviated as “TOC analysis”)

Apparatus: O•I-1010 (Wet Oxidation Method) manufactured by O•I Corporation

### EXAMPLE 1

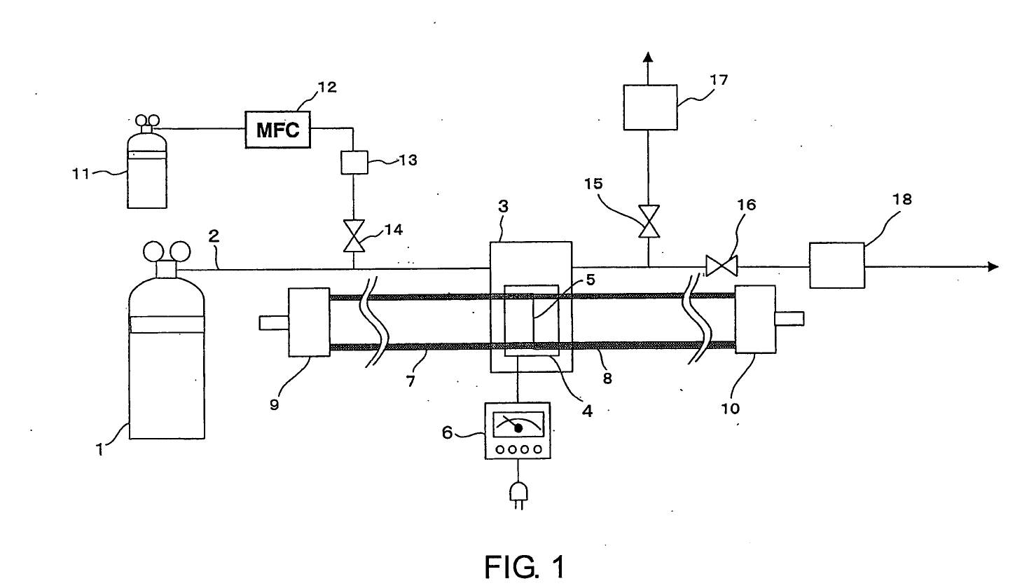

An evaluation apparatus in Example 1 will be described with reference to FIG. 1.

In FIG. 1, 1 denotes an inert gas supply source, 2 an inert gas supply pipe, 3 a bonding portion cover, 4 a bonding portion heater, 5 a bonding portion, 6 a heater power supply, 7 and 8 bonding pipes, 9 and 10 pipe sealing covers each with an orifice, 11 an oxygen bomb, 12 a mass flow controller, 13 a moisture generator, 14 an adjustment valve, 15 and 16 flow rate adjusting valves, 17 an FT-IR, and 18 an API-MS.

FIG. 1 is a schematic diagram of the apparatus capable of evaluating thermal decomposition characteristics of a resin, wherein the bonding pipe 7 and the bonding pipe 8 are bonded at the bonding portion 5. This evaluation apparatus comprises the bonding portion cover 3 hermetically covering the bonding portion including the heater 4 for heating the bonding portion 5 and the bonding portion 5, and the heater power supply 6. There are provided a mechanism (1 to 10) for reducing the oxygen concentration and the moisture concentration in an atmosphere of the bonding portion, a mechanism (11 to 14) for adjusting the oxygen concentration and the moisture concentration in the atmosphere of the bonding portion, and a mechanism (15 to 18) for measuring the oxygen concentration and the moisture concentration in the atmosphere of the bonding portion.

In this example, high-purity Ar was used as an inert gas for controlling the atmosphere and supplied at 1 L/min. As the gas supply pipe 2 for supplying the inert gas, use was made of a pipe of which the inner surface was subjected to electrochemical polishing and then applied with a chromium oxide treatment.

As the cover 3 covering the bonding portion 5 for controlling the bonding portion 5 in a low oxygen atmosphere and a low moisture concentration atmosphere, use was made of a container formed of a cycloolefin polymer (COP) (ZEONOR 1060 manufactured by ZEON Corporation) being a hydrocarbon-based resin made of carbon and hydrogen.

The API-MS 18 was disposed midway in an exhaust passage for the gas supplied to the bonding portion 5, thereby managing the moisture concentration (in the order of ppm) and the oxygen concentration. Further, the FT-IR 17 was disposed to examine the moisture concentration (in the order of %) and the thermal decomposition characteristics of the bonding resin members.

In this example, bonding was carried out by the use of the pipes 7 and 8 containing as a main component the foregoing ZEONOR 1060 being the COP and each having a length of 1 m. On the sides, opposte to the bonding portion 5, of the pipes 7 and 8, the pipe sealing covers 9 and 10 each having the orifice connected thereto were attached, respectively, for preventing back diffusion from the exterior.

The atmosphere inside the bonding portion cover 3 was Ar and, when thermal fusion bonding was implemented in a system where the oxygen concentration inside the bonding portion cover 3 was controlled at 1 vol %, the COP thermal decomposition temperature was 220 to 230° C.

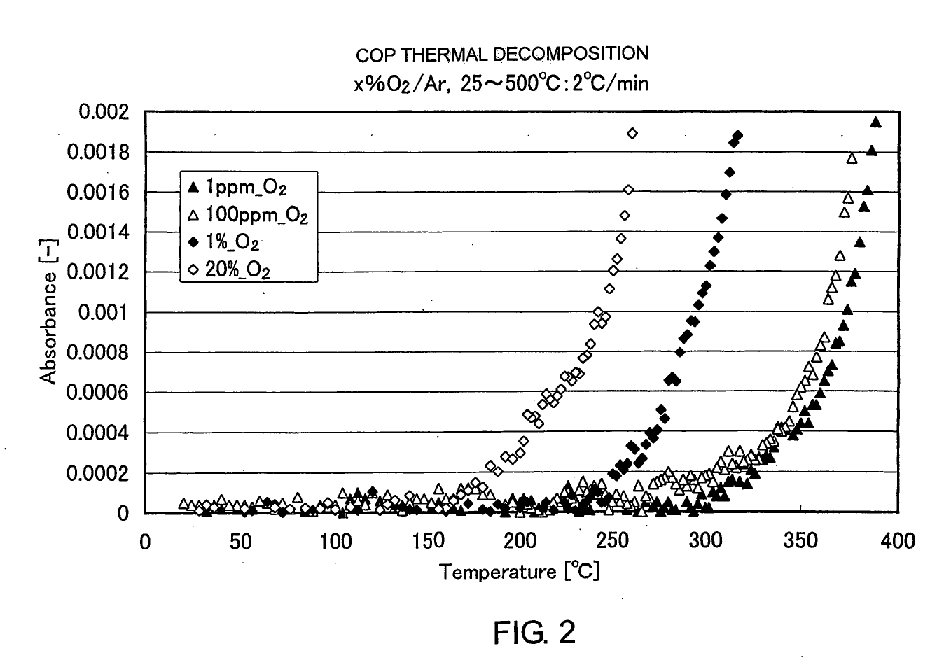

The results are shown in FIG. 2.

### EXAMPLE 2

By the use of the evaluation apparatus of Example 1, when thermal fusion bonding was implemented in a system where the oxygen concentration inside the bonding portion cover 3 was controlled at 100 vol ppm, the COP thermal decomposition temperature was 260 to 270° C. The results are shown in FIG. 2.

### EXAMPLE 3

By the use of the evaluation apparatus of Example 1, when thermal fusion bonding was implemented in a system where the oxygen concentration inside the bonding portion cover 3 was controlled at 1 vol ppm, the COP thermal decomposition temperature was 300 to 310° C. The results are shown in FIG. 2.

### EXAMPLE 4

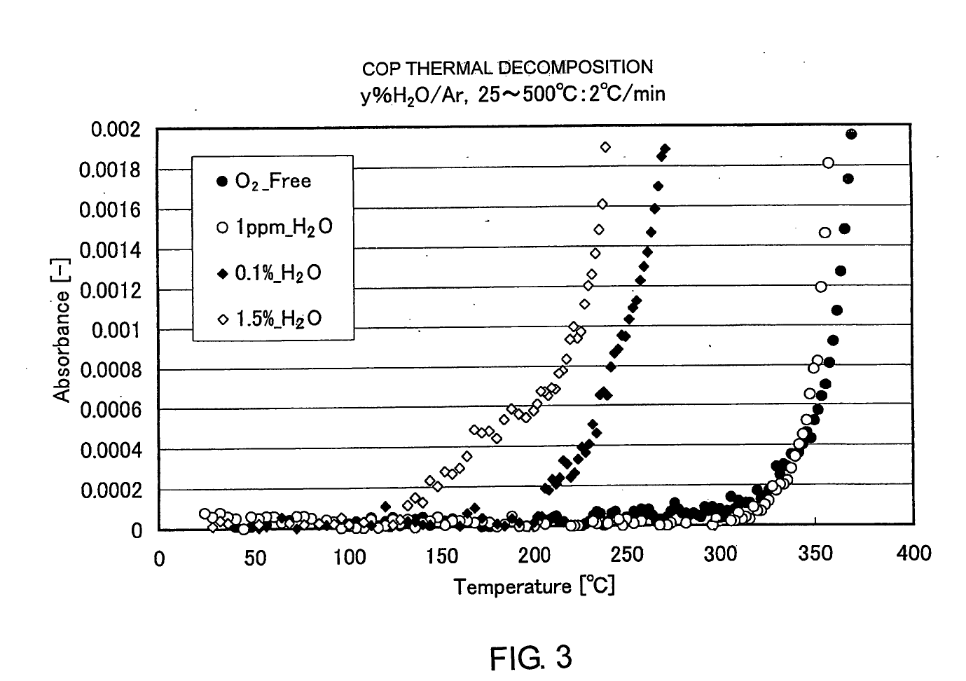

By the use of the evaluation apparatus of Example 1, when thermal fusion bonding was implemented in a system where the inert gas was supplied to the inside of the bonding portion cover 3 in advance and the inside of the bonding portion cover 3 was controlled in an oxygen-free state (<1 vol ppb), the COP thermal decomposition temperature was 300 to 310° C. The results are shown in FIG. 3.

### EXAMPLE 5

By the use of the evaluation apparatus of Example 1, when thermal fusion bonding was implemented in a system where the inert gas was supplied to the inside of the bonding portion cover 3 in advance and the inside of the bonding portion cover 3 was controlled in an oxygen-free state (<1 vol ppb) and where the moisture concentration inside the bonding portion cover 3 was controlled at 0.1 vol %, the COP thermal decomposition temperature was 200 to 210° C. The results are shown in FIG. 3.

### EXAMPLE 6

By the use of the evaluation apparatus of Example 1, when thermal fusion bonding was implemented in a system where the inert gas was supplied to the inside of the bonding portion cover 3 in advance and the inside of the bonding portion cover 3 was controlled in an oxygen-free state (<1 vol ppb) and where the moisture concentration inside the bonding portion cover 3 was controlled at 1 vol ppm, the COP thermal decomposition temperature was 300 to 310° C. The results are shown in FIG. 3.

### COMPARATIVE EXAMPLE 1

By the use of the evaluation apparatus of Example 1, when thermal fusion bonding was implemented in the state where the bonding portion 5 was open to the atmosphere, the COP thermal decomposition temperature was 150 to 160° C. The results are shown in FIG. 2.

### COMPARATIVE EXAMPLE 2

By the use of the evaluation apparatus of Example 1, when bonding was implemented in a system where the inert gas was supplied to the inside of the bonding portion cover 3 in advance and the inside of the bonding portion cover 3 was controlled in an oxygen-free state (<1 vol ppb) and where the moisture concentration inside the bonding portion cover 3 was controlled at 1.5 vol %, the COP thermal decomposition temperature was 120 to 130° C. The results are shown in FIG. 3.

In this comparative example, in order to confirm the influence exerted on the resin decomposition properties only by the moisture concentration, the evaluation was performed by setting the moisture concentration inside the bonding portion cover 3 to be 1.5 vol % while controlling the oxygen concentration inside the bonding portion cover 3 to be less than 1 vol ppb. This moisture concentration of 1.5 vol % is equivalent to the moisture concentration in the atmosphere-open state.

It can be confirmed from FIGS. 2 and 3 that the thermal decomposition temperature is shifted according to the oxygen concentration and the moisture concentration inside the bonding portion cover 3. That is, it is shown that the thermal decomposition of the bonding resin pipes 7 and 8 can be suppressed by controlling the oxygen concentration and the moisture concentration inside the bonding portion cover 3. It is seen that when the oxygen concentration inside the bonding portion cover 3 exceeds 1 vol %, the COP resin members are significantly degraded in a low-temperature region. The occurrence of the thermal decomposition in the low-temperature region means that the degradation of the resin members occurs during melting and bonding (during thermal fusion bonding), and the thermally decomposed resin members easily release organic matter. Therefore, the oxygen concentration inside the bonding portion cover 3 is preferably 1 vol % or less, and more preferably 100 vol ppm or less. It is further preferably 1 vol ppm or less.

Further, it is seen that when the moisture concentration exceeds 0.1 vol %, the resin members are significantly degraded in a low-temperature region. The moisture concentration also needs to be controlled like the oxygen concentration. Therefore, the moisture concentration inside the bonding portion cover 3 is preferably 0.1 vol % or less, and more preferably 1 vol ppm or less.

### EXAMPLE 7

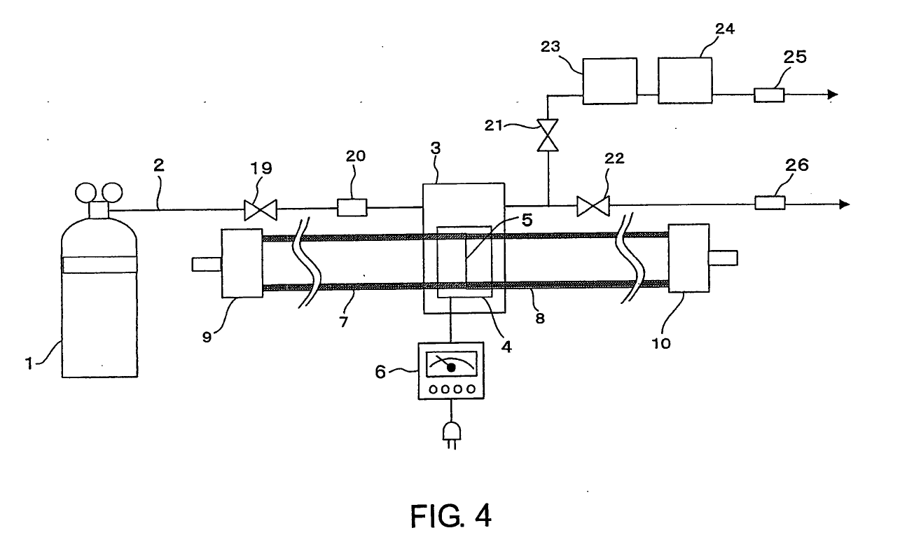

An elution amount evaluation was implemented with respect to a clean PVC pipe that was thermally fusion-bonded by the use of an atmosphere-controlled bonding (thermal fusion-bonding) apparatus shown in FIG. 4. The same numerals are assigned to constituent portions that are the same as those (1 to 10) in FIG. 1. What are newly added when constituting the apparatus are indicated as 19 to 26. 19 denotes a flow rate adjusting valve, 20 a check valve, 21 and 22 flow rate adjusting valves, 23 an oxygen analyzer, 24 a moisture analyzer, and 25 and 26 orifices.

As bonding pipes 7 and 8, use was made of an ESLON super clean pipe (clean PVC base material) (Φ 1 inch, 2 m) manufactured by Sekisui Chemical Co., Ltd. Thermal fusion bonding was performed at 10 portions in an atmosphere inside a bonding portion cover 3 where the oxygen concentration and the moisture concentration were each controlled at 1 vol ppm.

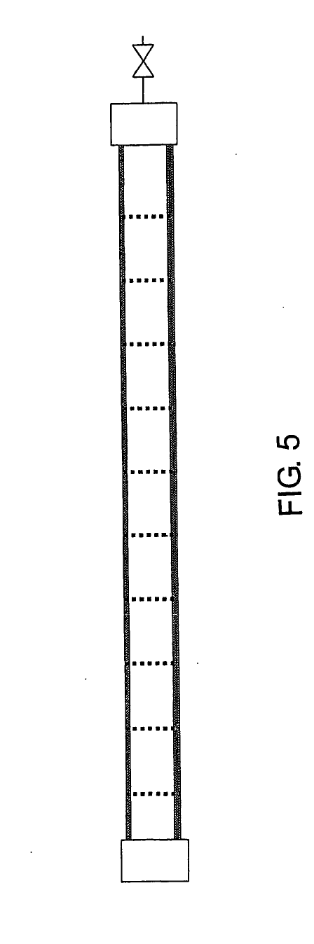

As shown in FIG. 5, the thermally fusion-bonded resin (clean PVC) pipe was filled with ultrapure water and sealed, and the water inside was left standing for three days and then taken out, thereby performing a TOC (water quality) analysis thereof. As the water used in the evaluation, use was made of ultrapure water having a TOC concentration of less than 0.5 μg/L, manufactured by Tohoku University's Future Information Industry Creation Center.

As a result of an analysis by the use of O•I-1010 (Wet Oxidation Method) manufactured by O•I Corporation, the TOC concentration was 0.7 μg/L.

The analysis results are shown in Table 1.

TABLE 1
TOC Elution Amount Evaluation Result

| | Thermally Fusion-Bonded Portions | |
|---|---|---|
| | (10 Portions in Total) | |
| | Atmosphere-Open | Atmosphere-Controlled |
| | Thermal Fusion Bonding | Thermal Fusion Bonding |
| | (Oxygen Concentration: | (Oxygen Concentration: |
| | 20% · Moisture | 1 ppm · Moisture |
| | Concentration: 1.5%) | Concentration: 1 ppm) |
| TOC Concentration | 6.9 | 0.7 |
| after 3 Days from | | |
| Filling of Water | | |
| (μg/L) | | |

Ultrapure Water TOC Concentration: <0.5 μg/L

### COMPARATIVE EXAMPLE 3

Thermal fusion bonding was carried out like in Example 6 except that the bonding portion cover 3 was opened to provide an atmosphere-open condition (oxygen concentration 20 vol %, moisture concentration 1.5 vol %). As a result of an analysis by the use of the analysis apparatus shown in Example 7, the TOC concentration was 6.9 μg/L. The analysis results are shown in the table.

As confirmable also from the table, it has been confirmed that the elution amount from the resin pipe thermally fusion-bonded in the atmosphere-open state with the bonding portion cover 3 being open is 6.9 μg/L in this example, while, the elution amount from the resin pipe thermally fusion-bonded in the state where the oxygen concentration and the moisture concentration in the atmosphere inside the bonding portion cover 3 are each controlled at 1 vol ppm is 0.7 μg/L, thus, there is about 10 times difference. That is, it has been demonstrated that, from resin members thermally fusion-bonded by the resin bonding apparatus or bonding method according to this invention, a new bonded resin member with small elution of TOC components can be supplied.

The bonding apparatus and bonding method of this invention are used as a bonding apparatus and bonding method when manufacturing ultrapure water supply pipes or other liquid or gas resin pipes, or resin members that contact a liquid or gas, in the electronic industry field such as in a semiconductor or liquid-crystal display plant that requires ultrapure water, gases, chemical liquids, and so on.

1. A bonding apparatus for bonding resin members to each other, wherein said resin members are bonded in the state where a bonding portion is covered.

2. The bonding apparatus according to claim 1, comprising means for raising a temperature of the bonding portion.

3. The bonding apparatus according to claim 2, wherein the means for raising the temperature of the bonding portion comprises at least one of a heater and a laser.

4. The bonding apparatus according to claim 1, wherein an inside atmosphere covering the bonding portion has an oxygen concentration of 1 vol % or less.

5. The bonding apparatus according to claim 1, wherein an inside atmosphere covering the bonding portion has a moisture concentration of 0.1 vol % or less.

6. The bonding apparatus according to claim 1, comprising a container covering the bonding portion, said container having a supply port for supplying an inert gas and an exhaust port for exhausting the inert-gas.

7. The bonding apparatus according to claim 1, wherein an inert gas is supplied to the inside covering the bonding portion.

8. The bonding apparatus according to claim 7, wherein the inert gas is a gas containing at least one of nitrogen, helium, neon, argon, krypton, and xenon.

9. The bonding apparatus according to claim 7, wherein a hydrogen gas is supplied.

10. The bonding apparatus according to claim 1, wherein a concentration of oxygen contained in a gas is 100 vol ppm or less.

11. The bonding apparatus according to claim 1, wherein a concentration of moisture contained in a gas is 100 vol ppm or less.

12. The bonding apparatus according to claim 1, wherein a member covering the bonding portion has an oxygen gas permeability of 1 vol % or less.

13. The bonding apparatus according to claim 12, wherein the member covering the bonding portion has a moisture permeability of 0.1 vol % or less.

14. The bonding apparatus according to claim 1, comprising a measuring apparatus capable of measuring at least one of an oxygen concentration and a moisture concentration of an inside atmosphere covering the bonding portion.

15. The bonding apparatus according to claim 1, wherein the resin members to be bonded are resin members containing a hydrocarbon or resin members containing a fluorocarbon.

16. The bonding apparatus according to claim 1, wherein the inside covering the bonding portion can be decompressed.

17. The bonding apparatus according to claim 1, wherein the inside covering the bonding portion can be repeatedly subjected to supply of a gas and decompression.

18. A bonding method for bonding resin members to each other, wherein said resin members are bonded in the state where a bonding portion is covered.

19. The bonding method according to claim 18, comprising means for raising a temperature of the bonding portion.

20. The bonding method according to claim 19, wherein the means for raising the temperature of the bonding portion uses at least one of a heater and a laser.

21. The bonding method according to claim 18, wherein an inside atmosphere covering the bonding portion has an oxygen concentration of 1 vol % or less.

22. The bonding method according to claim 18, wherein an inside atmosphere covering the bonding portion has a moisture concentration of 0.1 vol % or less.

23. The bonding method according to claim 18, wherein a container covering the bonding portion has a supply port for supplying a gas and an exhaust port for exhausting the gas.

24. The bonding method according to claim 18, wherein a gas is supplied to the inside covering the bonding portion.

25. The bonding method according to claim 24, wherein the inert gas is an inert gas containing at least one of nitrogen, helium, neon, argon, krypton, and xenon.

26. The bonding method according to claim 24, wherein a hydrogen gas is supplied.

27. The bonding method according to claim 18, wherein a concentration of oxygen contained in an inert gas is 100 vol ppm or less.

28. The bonding method according to claim 18, wherein a concentration of moisture contained in an inert gas is 100 vol ppm or less.

29. The bonding method according to claim 18, wherein a member covering the bonding portion has an oxygen gas permeability of 1 vol % or less.

30. The bonding method according to claim 18, wherein a member covering the bonding portion has a moisture permeability of 0.1 vol % or less.

31. The bonding method according to claim 18, having a measuring apparatus capable of measuring at least one of an oxygen concentration and a moisture concentration of an inside atmosphere covering the bonding portion.

32. The bonding method according to claim 18, wherein the resin members to be bonded are resin members containing a hydrocarbon or resin members containing a fluorocarbon.

33. The bonding method according to claim 18, wherein the inside covering the bonding portion can be decompressed.

34. The bonding method according to claim 18, wherein the inside covering the bonding portion can be repeatedly subjected to supply of a gas and decompression.

35. A bonding method using the apparatus according to claim 1 and comprising a first step of setting resin members to be bonded in the bonding apparatus, a second step of supplying an inert gas to the inside covering a bonding portion so as to reduce an oxygen concentration to 1% or less and a moisture concentration to 0.1% or less, a third step of heating and fusion-bonding the bonding portion, and a fourth step of cooling the bonding portion.

36. A bonded resin which is manufactured using the apparatus according to any of claims 1 to 17.

37. A bonded resin which is manufactured using the method according to any one of claims 18-35.
